(19) United States
(12) Patent Application Publication
(10) Pub. No.: US 2004/0131927 A1
(43) Pub. Date: Jul. 8, 2004

(54) Battery with insulative tubular housing

(76) Inventors: Arthur Holland, Commerce Twsp., MI (US); William Koetting, Davisburg, MI (US); Lindsay Newman, Royal Oak, MI (US)

Correspondence Address: ENERGY CONVERSION DEVICES, INC., 2956 WATERVIEW DRIVE, ROCHESTER HILLS, MI, 48309, US

(21) Appl. No.: 10/336,116

(22) Filed: Jan. 3, 2003

(51) Int. Cl. H01M 2/02

(52) U.S. Cl. 429/96; 429/159; 429/163

(57) ABSTRACT

A battery having an insulative tubular housing with a polygonal cross-section. The tubular housing may be formed of a paper.

### FIELD OF THE INVENTION

The present invention relates to electrochemical cells. In particular, the present invention relates to a new way of packaging electrochemical cells to form a battery.

### BACKGROUND OF THE INVENTION

In rechargeable electrochemical cells, weight and portability are important considerations. It is also advantageous for rechargeable cells to have long operating lives without the necessity of periodic maintenance. Rechargeable electrochemical cells are used in numerous consumer devices such as calculators, portable radios, and cellular phones. They are often configured into a sealed power pack that is designed as an integral part of a specific device. Rechargeable electrochemical cells can also be configured as larger “cell packs” or “battery packs”.

Rechargeable electrochemical cells may be classified as “nonaqueous” cells or “aqueous” cells. An example of a nonaqueous electrochemical cell is a lithium-ion cell which uses intercalation compounds for both anode and cathode, and a liquid organic or polymer electrolyte. Aqueous electrochemical cells may be classified as either “acidic” or “alkaline”. An example of an acidic electrochemical cell is a lead-acid cell which uses lead dioxide as the active material of the positive electrode and metallic lead, in a high-surface area porous structure, as the negative active material. Examples of alkaline electrochemical cells are nickel cadmium cells (Ni—Cd) and nickel-metal hydride cells (Ni—MH). Ni—MH cells use negative electrodes having a hydrogen absorbing alloy as the active material. The hydrogen absorbing alloy is capable of the reversible electrochemical storage of hydrogen. Ni—MH cells typically use a positive electrode having nickel hydroxide as the active material. The negative and positive electrodes are spaced apart in an alkaline electrolyte such as potassium hydroxide.

Upon application of an electrical potential across a Ni—MH cell, the hydrogen absorbing alloy active material of the negative electrode is charged by the electrochemical absorption of hydrogen and the electrochemical discharge of a hydroxyl ion, forming a metal hydride. This is shown in equation (1):

$$M + {H}_{2} O + {e}^{-} {{⟷}_{discharge}}^{charge} M - H + {OH}^{-} \qquad ( 1 )$$

The negative electrode reactions are reversible. Upon discharge, the stored hydrogen is released from the metal hydride to form a water molecule and release an electron.

Generally, the hydrogen storage alloy used for the negative electrode of nickel-metal hydride battery. A class of hydrogen storage alloys that may be used include the AB type alloys. Examples of AB type alloys include the TiNi and the MgNi alloys. Another class of hydrogen storage alloys which may be used include the AB₂ type hydrogen storage alloys. Examples of AB₂ type alloys include the binary ZrCr₂, ZrV₂, ZrMo₂ TiNi₂, and MgNi₂ alloys. Another class of hydrogen storage alloy is the AB₅ class of alloys. For some AB₅ types of alloys A may be represented by lanthanum, while B might be a transition metal such as Ni, Mn or Cr. An example of this type of AB₅ type alloy is LaNi₅. Other examples of AB₅ alloys include the rare-earth (Misch metal) alloys such as MmNi, and MnNiCrCoMnAl.

Other hydrogen absorbing alloys result from tailoring the local chemical order and local structural order by the incorporation of selected modifier elements into a host matrix. Disordered hydrogen absorbing alloys have a substantially increased density of catalytically active sites and storage sites compared to single or multi-phase crystalline materials. These additional sites are responsible for improved efficiency of electrochemical charging/discharging and an increase in electrical energy storage capacity. The nature and number of storage sites can even be designed independently of the catalytically active sites. More specifically, these alloys are tailored to allow bulk storage of the dissociated hydrogen atoms at bonding strengths within the range of reversibility suitable for use in secondary battery applications.

Some extremely efficient electrochemical hydrogen storage alloys were formulated, based on the disordered materials described above. These are the Ti—V—Zr—Ni type active materials such as disclosed in U.S. Pat. No. 4,551,400 (“the '400 Patent”) the disclosure of which is incorporated herein by reference. These materials reversibly form hydrides in order to store hydrogen. All the materials used in the '400 Patent utilize a generic Ti—V—Ni composition, where at least Ti, V, and Ni are present and may be modified with Cr, Zr, and Al. The materials of the '400 Patent are multiphase materials, which may contain, but are not limited to, one or more phases with C₁₄ and C₁ type crystal structures.

Other Ti—V—Zr—Ni alloys, also used for rechargeable hydrogen storage negative electrodes, are described in U.S. Pat. No. 4,728,586 (“the '586 Patent”), the contents of which is incorporated herein by reference. The '586 Patent describes a specific sub-class of Ti—V—Ni—Zr alloys comprising Ti, V, Zr, Ni, and a fifth component, Cr. The '586 Patent, mentions the possibility of additives and modifiers beyond the Ti, V, Zr, Ni, and Cr components of the alloys, and generally discusses specific additives and modifiers, the amounts and interactions of these modifiers, and the particular benefits that could be expected from them. Other hydrogen absorbing alloy materials are discussed in U.S. Pat. Nos. 5,096,667, 5,135,589, 5,277,999, 5,238,756, 5,407,761, and 5,536,591, the contents of which are incorporated herein by reference.

### SUMMARY OF THE INVENTION

An aspect of the present invention is a battery, comprising: an insulative tubular housing having a polygonal cross-section; and one or more electrochemical cells disposed end to end within the housing.

### BRIEF DESCRIPTION OF THE DRAWINGS

FIG. 1 shows a battery that includes a first and a second electrochemical cell placed end-to-end within a tubular housing;

FIG. 2 shows a cross-sectional view of the top end of the battery from FIG. 1;

FIG. 3 shows how air may pass within the tubular housing of the battery shown in FIG. 1;

FIG. 4 shows a battery pack formed by stacking six of the batteries shown in FIG. 1;

FIG. 5 shows a cross-sectional view of the battery pack from FIG. 4; and

FIG. 6A shows a cross-sectional view of a battery disposed within a tubular housing having a cross-section which is a triangle;

FIG. 6B shows a cross-sectional view of a battery disposed within a tubular housing having a cross-section which is a pentagon;

FIG. 6C shows a cross-sectional view of a battery disposed within a tubular housing having a cross-section which is a hexagon; and

FIG. 6D shows a cross-sectional view of a battery disposed within a tubular housing having a cross-section which is a rectangle.

### DETAILED DESCRIPTION OF THE INVENTION

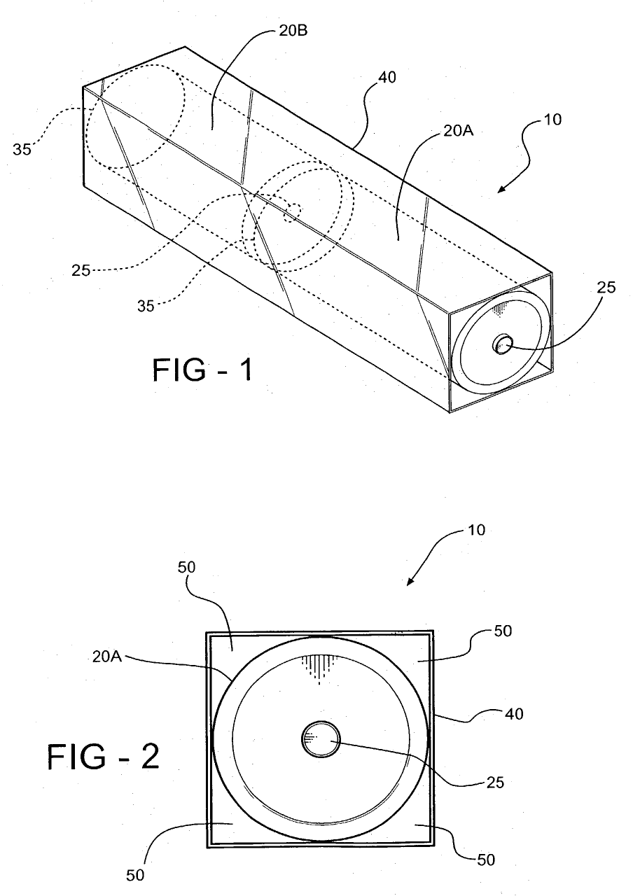

FIG. 1 shows an embodiment of the present invention. FIG. 1 shows a battery 10 comprising a first cylindrically shaped electrochemical cell 20A and a second cylindrically shaped electrochemical cell 20B. Each electrochemical cell has a top end or positive terminal 25 and a bottom end or negative terminal 35. The electrochemical cells are positioned end-to-end so that the bottom end (negative terminal) 35 of the first electrochemical cell 20A is adjacent to and electrically contacts the top end (positive terminal) 25 of the second electrochemical cell 20B. The first and second electrochemical cells are disposed within an insulative tubular housing 40.

The housing 40 may be formed of any electrically non-conducting material (for example, any dielectric material) Examples of possible materials includes papers, plastics and rubbers. Preferably, the housing is formed from a paper. Paper includes semisynthetic products made by chemically processing celluosic fibers. The paper may be dielectric kraft paper. The kraft paper may be vacuum impregnated with phenolic resins. The paper may be a vulcanized fiber. The vulcanized fiber may be produced from a cotton rag base paper. The vulcanized fiber is also referred to as a fish paper.

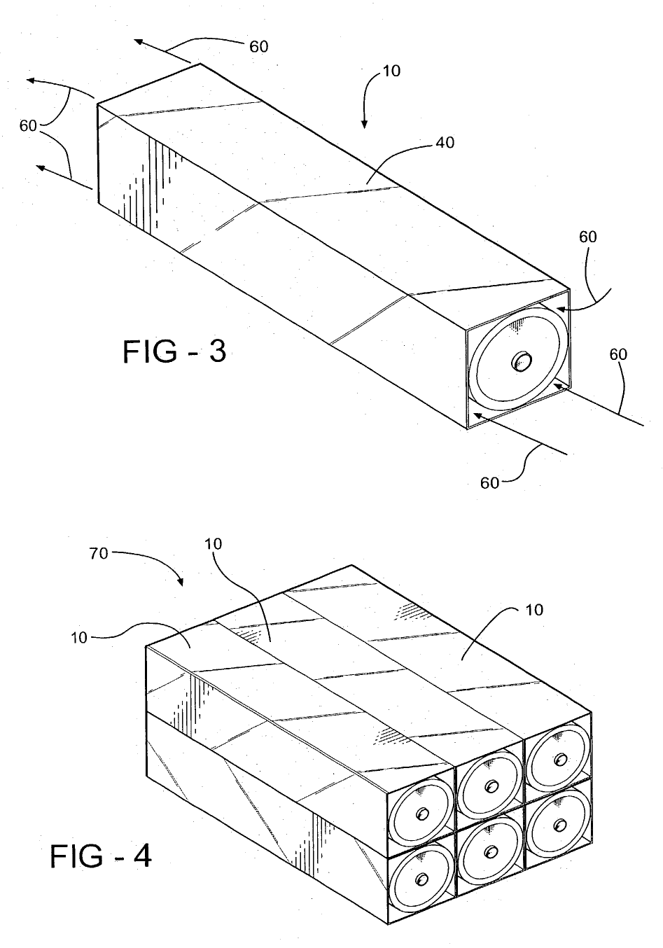

In the embodiment of the invention shown in FIG. 1, the tubular housing 40 has a square cross-section. The cross-sectional view of the battery 10 is shown in FIG. 2. FIG. 2 shows the top end 25 of the first electrochemical cell 20A. As shown in FIG. 2, gaps 50 exist between the sidwall surface of the electrochemical cell and the housing 40. The gaps 50 provide an area for which air (or even some other form of coolant) may circulate to cool the electrochemical cells disposed within the housing. A possible flow of air circulation 60 is shown in FIG. 3.

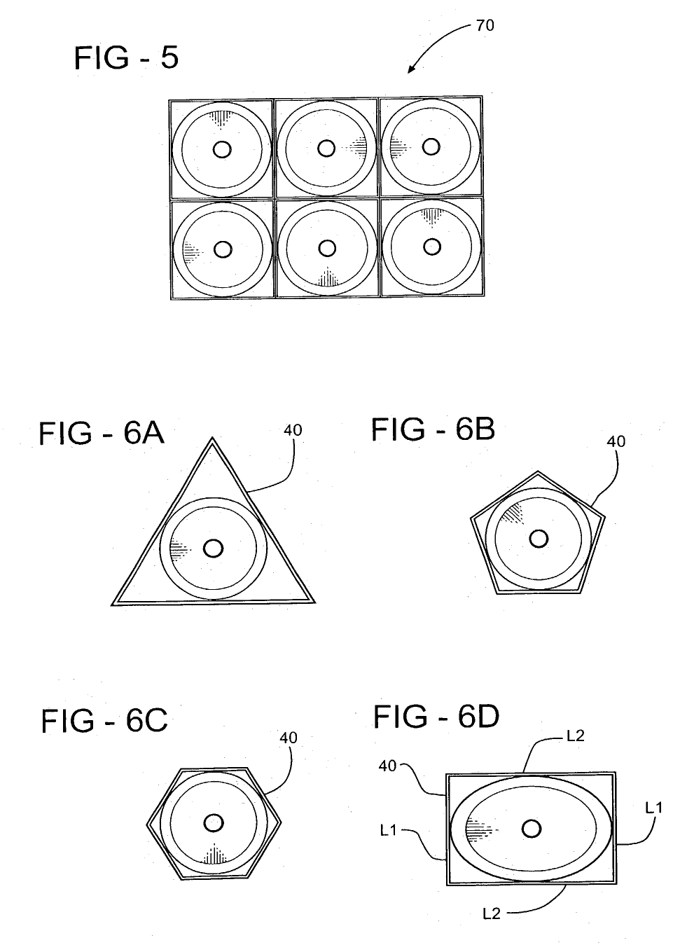

The square shape to the tubular housing facilitates the packing of multiple batteries together to form a battery pack. This is shown in FIG. 4 where a plurality of batteries 10 are stacked side-by-side to form a battery pack 70. FIG. 5 shows a cross-sectional view of the battery pack.

In the embodiment of the tubular housing shown in FIGS. 1-4, the cross-section of the tubular housing is in the form of a square. More generally, the insulative tubular housing may have any polygonal cross-section. That is, the cross-section of the tubular housing may be in the form of a polygon having three or more sides. Examples of the possible cross-sections are shown in FIGS. 6A-6D. In FIG. 6A, the polygonal cross-section is a triangle. In FIG. 6B, the polygonal cross-section is a pentagon. In FIG. 6C, the polygonal cross-section is a hexagon.

Preferably, all of the sides of the polygonal cross-section have substantially the same length. In this case, the polygonal cross-section is said to be “equilateral”. However, it is possible that two or more of the sides of the polygonal cross-section may be have different lengths. In this case, the polygonal cross-section is said to be “non-equilateral”. For example, rather using an insulative tubular housing having a square cross-section, it is possible to use an insulative tubular housing having a rectangular cross-section as shown in FIG. 6D. As shown in FIG. 6D, two parallel sides have a length L1 while the other two parallel sides have a length L2 (where L1 is less than L2). It is possible that an insulative tubular housing having a rectangular cross-section may be used to house electrochemical cells that have an oval cross-section as shown in FIG. 6D. This may be the case for a flat-wound battery.

Furthermore, it is conceivable that rather than having a polygonal cross-section, the insulative tubing simply have a cross-sectional shape that is different from the cross-sectional shape of the electrochemical cells housed within the tube. Since the shapes of the electrochemical cell and the tube are different there will still be gaps between the sidewall (or sidewalls) of the electrochemical cell and the wall (or walls) of the tube. These gaps may be used so that air may circulate inside the tube and come into contact with the surface of the electrochemical cell. The circulated air may be used to cool the electrochemical cell.

In addition, it is noted that while only two electrochemical cells are housed end-to-end in FIG. 1, it is possible that more than two electrochemical cells be housed end-to-end in the insulative tubular housing. In addition, it is also possible that only a single electrochemical cell be disposed within the tubular housing.

Referring again to FIGS. 4 and 5 it is seen that the insulative tubular housing prevents the case of a first electrochemical cell from touching the case of a second electrochemical cell has been placed to the side of the first cell in a battery pack. This is very use when the case of each of the electrochemical cells is formed from a metallic material such as a pure metal or a metal alloy (or formed from some other conductive material).

Electrochemical cells having metallic cases may thus be disposed in the insulative tubular housing without the need to use any additional insulative wrapping around the metal cases. The insulative tubular housing will prevent the metallic case of one of the electrochemical cells from making electrical contact with the metallic case another electrochemical cell that has been placed to the side of the first in the battery pack. Hence, the insulative tubular housing eliminates the need to use any additional insulative wrapping (such as an insulative plastic shrink wrap) around the casing of electrochemical cells that are formed of a metallic material.

The electrochemical cells used in the present invention may be any electrochemical cells known in the art. Preferably, the electrochemical cells are alkaline electrochemical cells. The alkaline electrochemical cell use an alkaline electrolyte. The alkaline electrolyte is preferably an aqueous solution of an alkali metal hydroxide. The alkali metal hydroxide preferably includes potassium hydroxide, lithium hydroxide, or sodium hydroxide or mixtures thereof. Preferably, the electrochemical cells are nickel-metal hydride electrochemical cells or nickel-cadmium electrochemical cells. More preferably, the electrochemical cells are nickel-metal hydride electrochemical cells. Nickel metal hydride cells use a negative electrode that includes a hydrogen storage alloy as the active material and a positive electrode that includes a nickel hydroxide material as the active material. Generally, any hydrogen storage alloy may be used as the active electrode material for the negative electrode and any nickel hydroxide material may be used as the active electrode material for the positive electrode. Examples of hydrogen storage alloys were discussed above.

While the invention has been described in connection with preferred embodiments and procedures, it is to be understood that it is not intended to limit the invention to the preferred embodiments and procedures. On the contrary, it is intended to cover all alternatives, modifications and equivalence which may be included within the spirit and scope of the invention as defined by the claims appended hereinafter.

We claim:

1. A battery, comprising:
an insulative tubular housing having a polygonal cross-section; and
one or more electrochemical cells disposed end to end within said housing.

2. The battery of claim 1, wherein said electrochemical cells are cylindrical.

2. The battery of claim 1, wherein said polygonal cross-section is equilateral.

3. The battery of claim 1, wherein said polygonal cross-sectional is non-equilateral.

4. The battery of claim 1, wherein said polygonal cross-section is a square.

5. The battery of claim 1, wherein said insulative housing comprises a paper.

6. The battery of claim 1, wherein said electrochemical cells are nickel-metal hydride cells.

7. The battery of claim 1, wherein said electrochemical cells are alkaline cells.

8. The battery of claim 1, wherein said electrochemical cells have metallic cases.

9. The battery of claim 1, wherein said one or more electrochemical cells is a plurality of electrochemical cells.
